(19) United States
(12) Patent Application Publication
(10) Pub. No.: US 2020/0156927 A1
(43) Pub. Date: May 21, 2020

(54) Girth Strap System

(71) Applicant: Hammersmith Nominees Pty Ltd, West Perth (AU)

(72) Inventors: Ronald Gordon Bates, West Perth (AU); Them Phat Tran, Dianella (AU)

(21) Appl. No.: 16/683,317

(22) Filed: Nov. 14, 2019

(30) Foreign Application Priority Data
Nov. 15, 2018 (AU) 2018904355

(51) Int. Cl. B68C 1/14

(52) U.S. Cl. CPC B68C 1/14; A44B 11/04; B68C 2001/142

(57) ABSTRACT

A girth strap system for co-operating with a girth for passing under the barrel of an animal to secure a saddle to the back of the animal. The system has a girth strap buckle configured for mounting to a saddle, and a girth strap configured to co-operate with the girth strap buckle to detachably fasten the girth strap to the saddle. The girth strap has a fastening portion at one end and a securing portion at the other end, and the securing portion co-operates with the girth.

### REFERENCE TO EARLIER APPLICATION

This application claims priority to Australian Provisional Application No. 2018904355, the entire contents of which is incorporated herein by reference.

### TECHNICAL FIELD

The present invention relates to a system for girth straps of a saddle for equestrian use.

### BACKGROUND

Conventionally, English-style and Australian-style equestrian saddles use a girth that passes under the barrel of the animal to hold the saddle on the animal's back. Girth straps, sometimes called billets, are a critical component of a saddle as they enable the girth to be fastened to either side of the saddle. The girth straps are fixed to the saddle and typically provide a mechanism to adjust the girth in order to secure the saddle on the back of the horse. Generally, this is accomplished by providing a series of punch holes in the girth strap. In use, the strap can be pulled through a buckle on the girth until taut and then held at that position by inserting the prong of the buckle through the nearest hole in the girth strap. The girth usually has two or three buckles at each end for attachment to a corresponding girth strap, or billet, on each side of the saddle.

Girth straps are often the first part of the saddle to wear and need replacing. Traditionally, girth straps need to be cut off so that new straps can be sewn back on the saddle. The replacement girth straps will be hand-sewn and the quality of the repair is dependent on thread strength, leather strength and skill of the saddle repairer.

Girth strap reliability is critical to the safety of a saddle. Should a girth strap fail, the saddle may come loose and cause the rider and saddle to fall free of the equine.

It is desirable to provide a girth strap that can be readily removed and securely replaced, or at least provide a useful alternative to existing girth straps.

### SUMMARY

The present invention is directed to providing a girth strap system comprising a girth strap that can be detachably fastened to a saddle so that, when the girth strap needs to be replaced, it can be detached and replaced with a new strap. In particular, the present invention provides a girth strap system, said system comprising: a girth strap buckle, said girth strap buckle being configured for mounting to a saddle; and a girth strap configured to co-operate with the girth strap buckle to detachably fasten the girth strap to the saddle, said girth strap having a fastening portion at one end and a securing portion at the other end, wherein:
the securing portion is configured to co-operate with a girth for passing under the barrel of an animal to secure the saddle to the back of the animal; and
the fastening portion comprises a band and a stopper; and
   the fastening portion is configured for threading the band through the girth strap buckle so that, in a fastened configuration, the stopper contacts a retaining element of the girth strap buckle to retain the fastening portion in the fastened configuration.

Thus, the present invention provides a girth strap buckle, said girth strap buckle being configured for mounting to a saddle and configured to co-operate with a girth strap to detachably fasten the girth strap to the saddle, wherein the girth strap buckle comprises a retaining element configured to contact a stopper of the girth strap, said girth strap having a fastening portion at one end and a securing portion at the other end, wherein:
the securing portion is configured to co-operate with a girth for passing under the barrel of an animal to secure the saddle to the back of the animal; and
the fastening portion comprises a band and the stopper; and
the fastening portion is configured for threading the band through the girth strap buckle so that, in a fastened configuration, the stopper contacts a retaining element of the girth strap buckle to retain the fastening portion in the fastened configuration.

In addition, the present invention provides a detachable girth strap, said girth strap being configured to co-operate with a girth strap buckle to detachably fasten the girth strap to a saddle, the girth strap buckle being configured for mounting to the saddle and comprising a retaining element configured to contact a stopper of the girth strap, wherein
the girth strap has a fastening portion at one end and a securing portion at the other end, and wherein:
the securing portion is configured to co-operate with a girth for passing under the barrel of an animal to secure the saddle to the back of the animal; and
the fastening portion comprises a band and the stopper; and
the fastening portion is configured for threading the band through the girth strap buckle so that, in a fastened configuration, the stopper contacts a retaining element of the girth strap buckle to retain the fastening portion in the fastened configuration.

The present invention also provides a saddle, such as a saddle for equestrian use, comprising, on each side of a seat, one or more girth strap buckles.

A method of fastening a detachable girth strap to a saddle is also provided. The method comprises threading the band through the girth strap buckle so that the stopper contacts the retaining element of the girth strap buckle to retain the fastening portion in the fastened configuration.

### BRIEF DESCRIPTION OF THE DRAWINGS

Various embodiments of the present invention are described, by way of example only, with reference to the following drawings.

FIG. 1 is schematic front view of a mounted girth strap buckle.

FIGS. 2 to 10 illustrate the steps for detachably fastening a girth strap to a saddle using the girth strap buckle of FIG. 1.

FIG. 11 shows a rear view of an unmounted girth strap buckle to which a girth strap is fastened.

FIG. 12 shows a side view of the unmounted fastened girth strap buckle of FIG. 11.

FIG. 13 shows a front view of the unmounted fastened girth strap buckle of FIG. 11.

FIG. 14 shows a perspective view of the unmounted fastened girth strap buckle of FIG. 11.

FIG. 15 shows a perspective front view of an unmounted and unfastened girth strap buckle.

FIG. 16 shows a perspective rear view of the girth strap buckle of FIG. 15.

FIGS. 17A-17H show perspective front, perspective rear, front, rear, top, bottom, left side and right side views, respectively, of an unmounted and unfastened girth strap buckle.

FIG. 18 shows a side view of the fastening portion of a detachable girth strap.

FIG. 19 shows a front view of the fastening portion of the detachable girth strap of FIG. 18.

### DETAILED DESCRIPTION

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

As used herein, the singular forms “a,” “an,” and “the” designate both the singular and the plural, unless expressly stated to designate the singular only.

The term “about” and the use of ranges in general, whether or not qualified by the term about, means that the number comprehended is not limited to the exact number set forth herein, and is intended to refer to ranges substantially within the quoted range while not departing from the scope of the invention. As used herein, “about” will be understood by persons of ordinary skill in the art and will vary to some extent on the context in which it is used. If there are uses of the term which are not clear to persons of ordinary skill in the art given the context in which it is used, “about” will mean up to plus or minus 10% of the particular term.

In addition, where dimensions are described herein, it will be appreciated that plus or minus (±) typical manufacturing tolerances are applicable to those values. As appreciated by those in the art, manufacturing tolerances may be determined to achieve a desired mean and standard deviation of manufactured components in relation to the ideal component profile.

The present invention provides a girth strap system, said system comprising: a girth strap buckle, said girth strap buckle being configured for mounting to a saddle; and a girth strap configured to co-operate with the girth strap buckle to detachably fasten the girth strap to the saddle, said girth strap having a fastening portion at one end and a securing portion at the other end, wherein:
the securing portion is configured to co-operate with a girth for passing under the barrel of an animal to secure the saddle to the back of the animal; and
the fastening portion comprises a band and a stopper; and
the fastening portion is configured for threading the band through the girth strap buckle so that, in a fastened configuration, the stopper contacts a retaining element of the girth strap buckle to retain the fastening portion in the fastened configuration.

The securing portion of the girth strap may have a configuration that corresponds to that of a conventional fixed girth strap so that the girth strap of the present invention is compatible with a conventional girth. Accordingly, the securing portion of the girth strap may be a leather strap. The girth strap typically has a series of adjustment holes configured to permit the girth to be buckled to the girth strap and for adjusting the position of the girth buckled to the securing portion.

The fastening portion of the girth strap comprises a band and a stopper. The stopper may project from a face of the band. In some other embodiments, the stopper may be appended and suitably fixed to the end of the band.

The band is a flexible section of the fastening portion. The band may be made from webbing, such as webbing that is woven from synthetic multifilament yarn. The webbing may be industrial webbing. The webbing may be made of a polyamide, such as a nylon, or polyester. In some embodiments, nylon yarn may be preferred because of its superior elongation characteristics. In some other embodiments, it may be preferred for the webbing to be made of polyester. In some embodiments, the webbing may be about 20 mm to about 30 mm wide, such as about 25.4 mm wide (about 1 inch wide). In some embodiments, the webbing may be about 1 mm to about 1.6 mm thick, such as about 1.3 mm thick.

In some embodiments, two or more lengths of webbing may be used to form the band. For example, the webbing for the section of the band that will be disposed within the girth strap buckle when the girth strap is fastening to the saddle may be wider and/or thicker than a section of webbing connecting the first section to the securing portion. The webbing of the first section may be about 20 mm to about 30 mm wide (e.g. about 25.4 mm wide) and may be about 1 mm to about 1.6 mm thick (e.g. about 1.3 mm thick). The webbing in the section in between the first section and the securing portion may be about 18 mm to about 28 mm wide (e.g. about 22.22 mm wide (about ⅞ inch)) and may be about 1.5 mm to about 2.5 mm thick (e.g. about 2 mm thick). In some embodiments, the lengths of webbing may be different colours.

The ends of the webbing are typically fused or sealed to prevent fraying. In some embodiments, the ends of the webbing are heat sealed. In heat sealing, fibres in the webbing are melted and fused together. Sealing may be performed at the same time or after cutting the webbing. For example, the webbing may be hot cut to simultaneously cut and heat seal the webbing.

The stopper projects relative to the band so that, when the fastening portion is in the fastened configuration, the stopper contacts a retaining element of the girth strap buckle to retain the fastening portion in the fastened configuration. The stopper may project from a face of the band. The stopper is suitably fixed so that it will not detach from the remainder of the fastening portion in ordinary use.

The height of the stopper is the distance the stopper projects from the face of the band. In some embodiments, the height of the stopper is equal to, or greater than, the thickness of the underlying band. In some embodiments, the height of the stopper is substantially the same as, or greater than, the thickness of the frame of the buckle. The stopper may be about 1.25-2.5 mm high, such as about 1.6 mm high or about 2 mm high.

The stopper may extend, width-wise, across the full width of the band. The length of the stopper along the band may be less than the width of the stopper. Typically, the length of the stopper is greater than the height of the stopper.

In some embodiments, the stopper may be formed using a short section of webbing. The webbing may be the same type of webbing as the band or a different type of webbing. Thus, a short length of a type of webbing as described above may be suitable forming the stopper. In some embodiments, the webbing may be about 20 mm to about 30 mm wide (e.g. about 25.4 mm wide) and may be about 1.3 mm to about 2.0 mm thick (e.g. about 1.5 mm or about 1.6 mm thick). The webbing of the stopper may be a different colour to the webbing of the band. The stopper can be stitched to the band. In some embodiments, the stopper may be adhered and sewn to the band. The ends of the short section of webbing forming the stopper are typically fused or sealed to prevent fraying as described above. The sealed edges are typically stiffer than the unsealed webbing. Thus, the sealed edges of a webbing stopper can contribute to the stopper being suitably stiff so that it can contact the retaining element of the girth strap buckle to retain the fastening portion in the fastened configuration. In addition, the relatively short length of the stopper and the stitching used to sew the stopper to the band may each also contribute to the stiffness of the stopper.

In some embodiments with a webbing stopper, the face of a sealed edge is the part of the stopper that contacts the retaining element.

The girth strap of the present invention may include an intermediate section at which the securing portion and the fastening portion are joined. Typically, the band and the securing portion overlap at the intermediate section so they can be joined together. At this intermediate section, the band may be sewn to the end of the securing portion. In some embodiments, the band may be adhered and sewn to the end of the securing portion.

The band may about one third to about one quarter the full thickness of the securing portion. In some embodiments, in the intermediate section, the securing portion may be tapered as it reaches the end of the intermediate section so that there is a gradual change in thickness. In some embodiments the change in thickness may extend along the last half to one third of the intermediate section. At the end of the intermediate section the thickness, including the band, may be twice the thickness of the band alone.

The girth strap buckle of the girth strap system is configured for mounting to a saddle and to co-operate with the fastening portion of the girth strap. Accordingly, in use, the girth strap buckle will be mounted to the saddle so that it can be used to detachably fasten the girth straps to the saddle. Conventionally, an equestrian saddle comprises a saddle flap extending downwardly from each side of the seat and overlying a saddle panel at that side. The girth straps are typically locates so that they lie underneath the flap and are mounted to the tree of the saddle. Accordingly, in embodiments of the present invention, the girth strap buckle may be mounted to the tree of the saddle. Also, in some embodiments, the girth strap buckle may be mounted so that any girth strap fastened to it will lie underneath the flap. That is, the girth strap system of the present invention is typically mounted to a saddle so that the girth strap lies in the same manner as conventional fixed girth straps.

The present invention provides a saddle comprising one or more girth strap buckles mounted of each side of the seat. The saddle may comprise two or more, such as three, girth strap buckles. In some embodiments, the saddle comprises plurality of girth strap buckles so that the position of the girth straps can be adjusted and reconfigured to adapt the saddle to the riding application or the animal with which the saddle will be used. For example, there may be a centrally placed spare fitting. In some embodiments, an additional girth buckle may be mounted to the rearmost position on the tree on each side of the saddle. The additional rear girth buckles can be tucked between the panel and tree, so that a fitter can access the buckle if desired.

The girth strap buckle of the present invention comprises a retaining element for contacting the stopper of the fastening portion to retain the fastening portion in the fastened configuration. A load on the girth strap that might draw the band back through the buckle, such as the loads typically encounter in use when securing the girth, will further urge the stopper against the retaining element. Openings and members of the buckle may be configured to favourably align the stopper against the retaining element when the girth strap is in use. Members of the buckle may be offset and/or narrowed to form a recess to favourably align the band and/or the stopper. When not in use, the position of the girth strap can be adjusted to loosen the band and unfasten the fastening portion.

The retaining element may be one or more members that project or extend so as to contact the stopper when the band is threaded through the buckle. In some embodiments, the girth strap buckle comprises a frame and the retaining element is a first crossbar extending across the frame. In some embodiment, the first crossbar may extend across the frame within plane of the frame. In some embodiments, the first crossbar may be offset from the plane of the frame. The first crossbar may be offset so that the majority of the length of the first crossbar is offset from the plane of the frame. The offset distance may be one quarter to one half the height of stopper.

The girth strap buckle may be mounted so that the first crossbar is offset towards the saddle.

As the girth straps are typically mounted so that the strap lies underneath the flap, the buckle is also positioned underneath the flap. If the fastened buckle (i.e. the buckle including the fastening portion in the fastened configuration) is too thick, it can be felt through the flap by the rider's leg. This may irritate the rider. In addition, if the fastened buckle is too thick, it may form a friction point at which the saddle flap may wear more quickly. Accordingly, it can be desirable for the fastened buckle to be as thin as possible. A thinner fastened buckle may enhance the rider's contact and comfort.

The offset first crossbar may enable the girth strap to be fastened to the buckle with a reduced overall thickness. In some embodiments, in the fastened configuration, two layers of the band lie to one side of the first crossbar. By offsetting the first crossbar, the overall thickness of the fastened buckle may be reduced.

In some embodiments, the girth strap buckle may be about half the thickness of the securing portion. The fastened buckle may be thinner than the intermediate section. Furthermore, the fastened buckle may be substantially the same thickness or thinner than the securing portion. In some embodiments, the fastened buckle may be less than 8 mm thick. The fastened buckle may be may be less than 6 mm thick, such as about 5 mm thick, for example, about 4.6 mm thick.

The buckle may be made of a metal alloy, for example steel. The buckle may be a stamped part or a cast part. In some embodiments, the buckle may be epoxy coated.

Corners on the buckle may be rounded. The corners may be rounded so that there are no sharp corners on the buckle. Sharp corners may create friction points that lead to parts of the girth strap or other parts of the saddle, such as the flap, wearing.

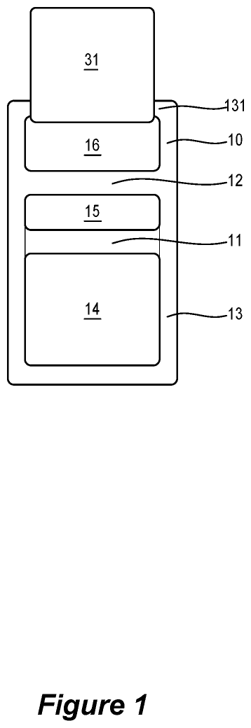

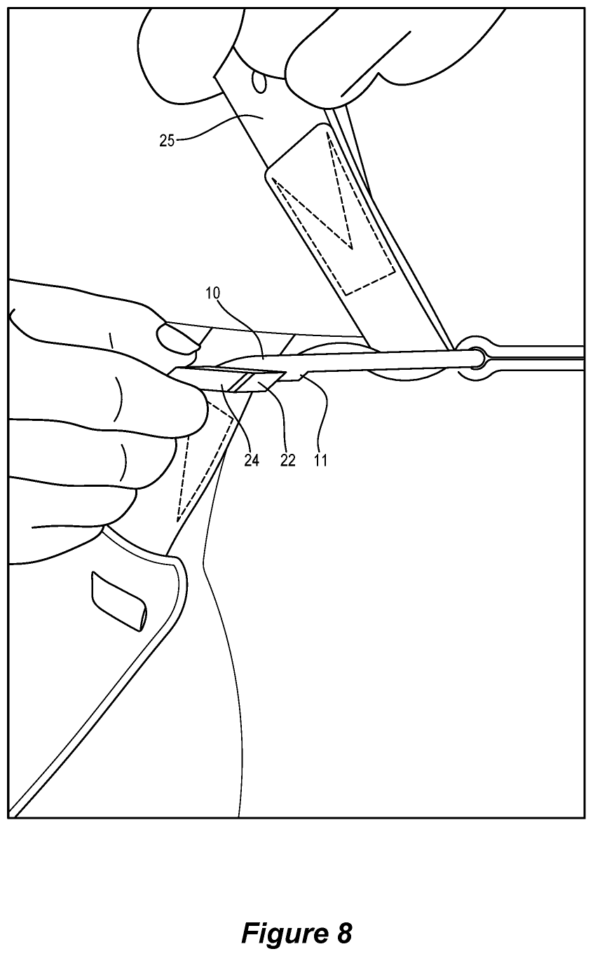

FIG. 1 is a schematic representation of an embodiment of the girth strap buckle 10 that is mounted to a saddle. The girth strap buckle 10 includes a first crossbar 11 and a second crossbar 12 that extend across the frame 13 of the buckle 10. In this embodiment, the first crossbar 11 extends so that the majority of the first crossbar 11 is offset from the plane of the frame 13. In this embodiment, the girth strap buckle 10 is mounted so that the first crossbar is offset towards the side facing the saddle (see FIG. 8).

The frame 13 and the first crossbar 11 delimit a first opening 14. The frame 13, the first crossbar 11 and the second crossbar 12 delimit a second opening 15. In addition, the frame 13 and the second crossbar 12 delimit a third opening 16. In this embodiment, the second opening 15 is smaller than the first opening 14 and the third opening 16.

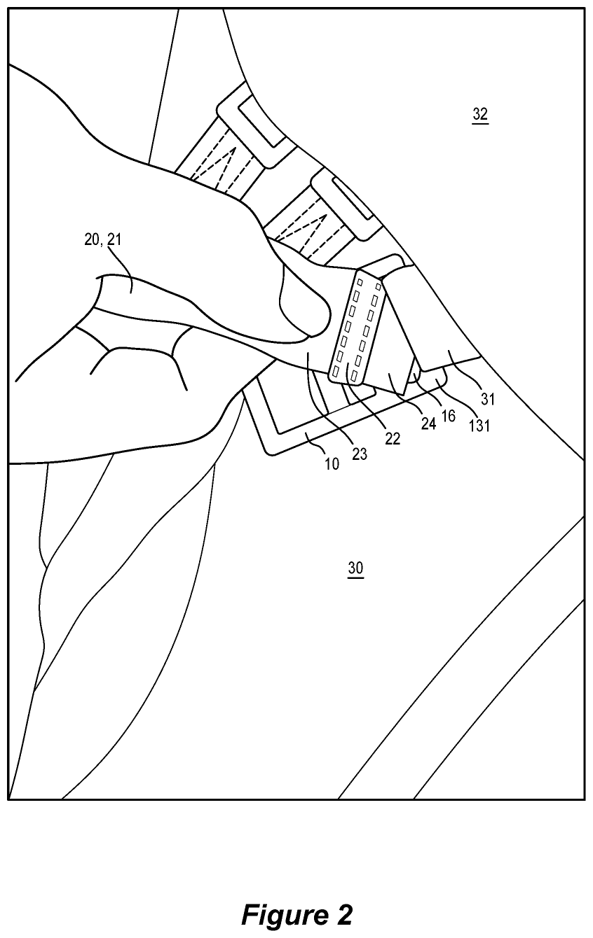

The buckle 10 is mounted to the saddle by webbing 31 that is looped through the third opening 16. The webbing 31 is fixed to the tree (not shown) of the saddle. The loop of webbing 31 permits the buckle 10 to at least rotate around the axis of the top-bar 131 of the frame 13. This facilitates the threading of the fastening portion 21 (see FIGS. 2-10) through the buckle 10.

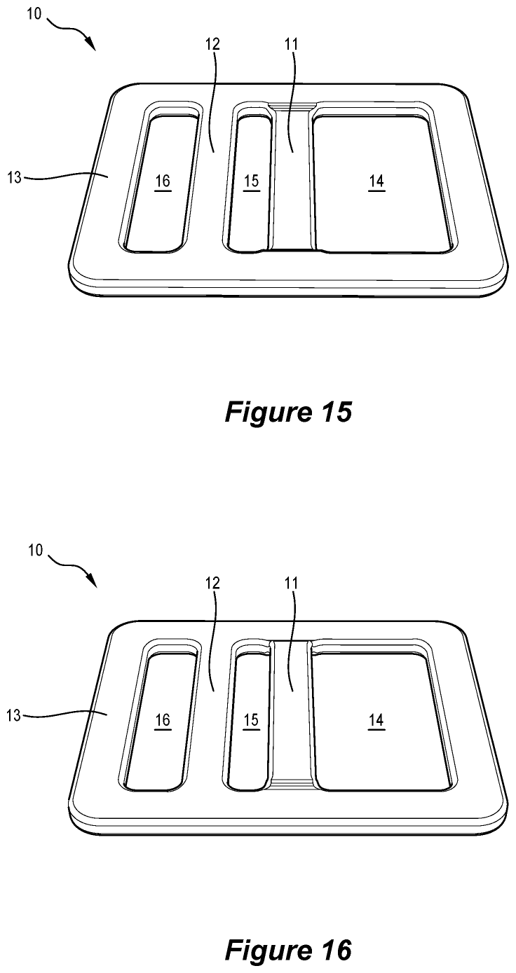

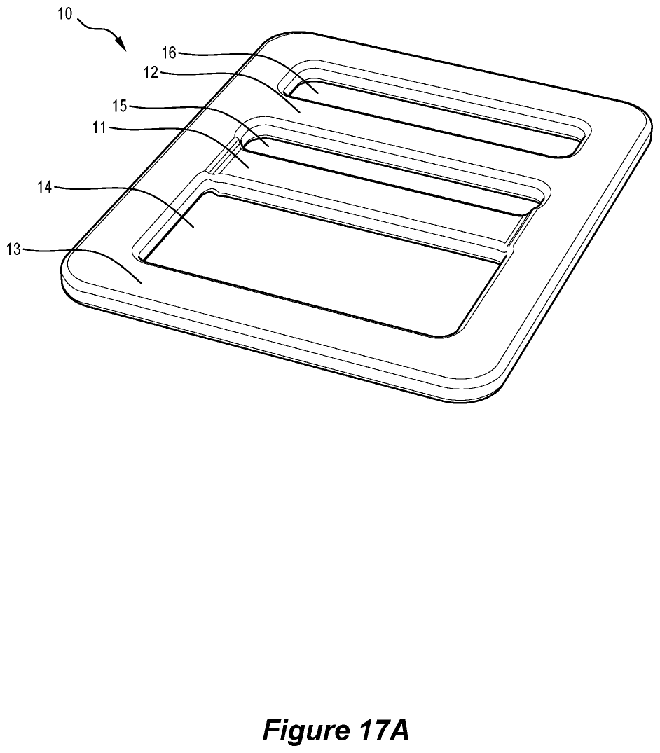

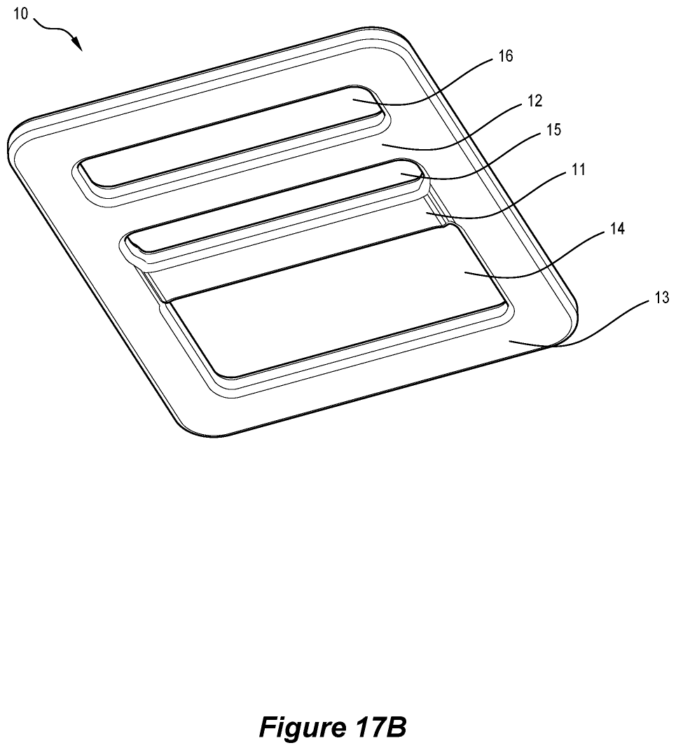

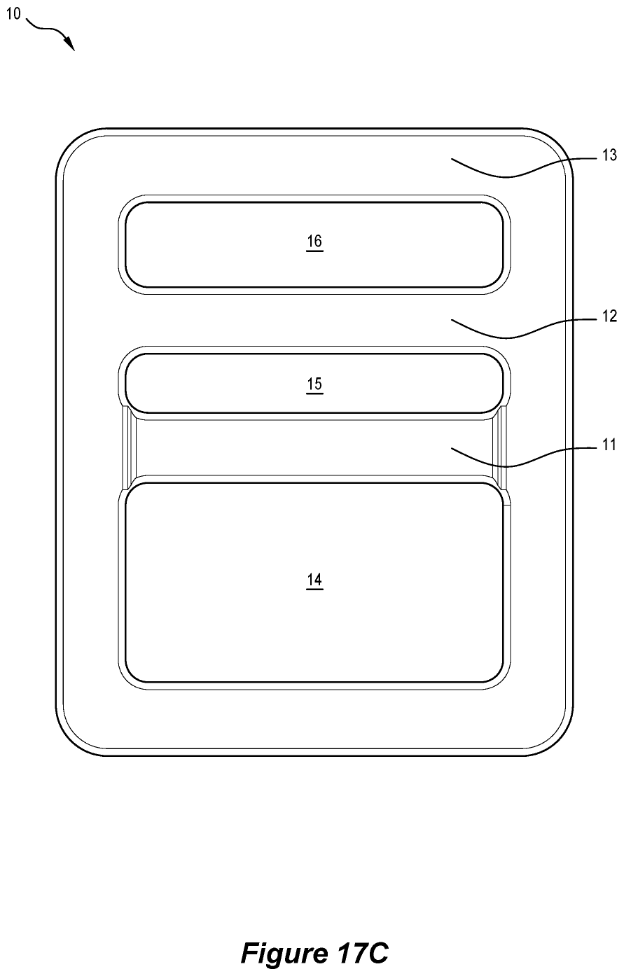

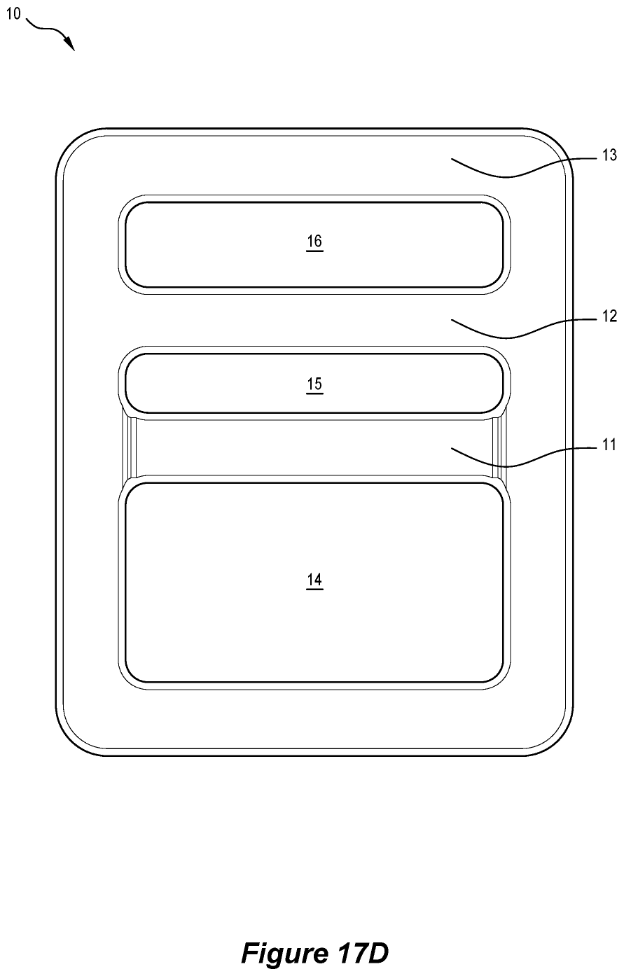

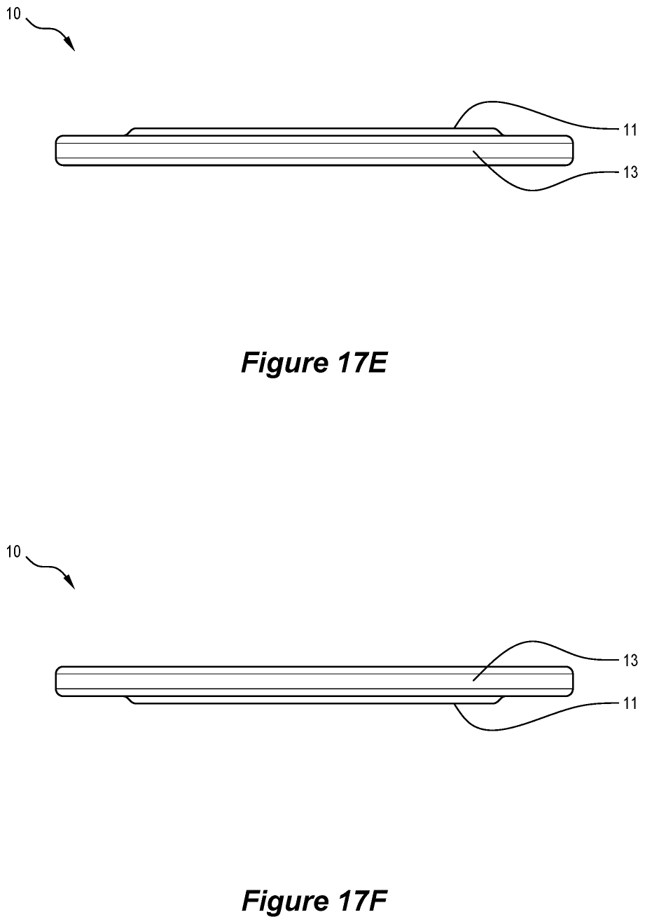

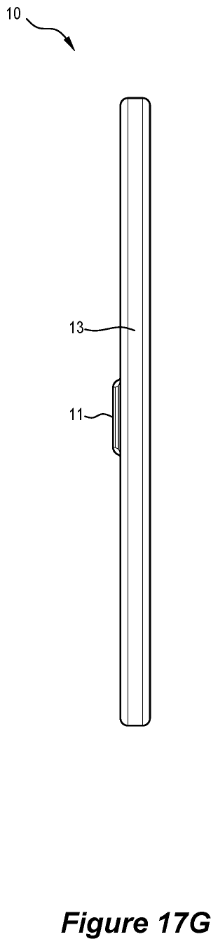

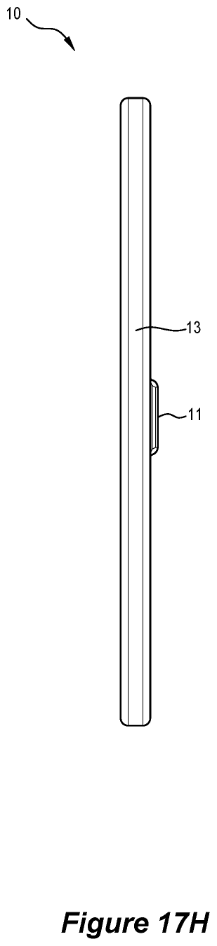

Another embodiment of the girth strap buckle 10 is shown in FIGS. 15 and 16. A further embodiment is shown in FIGS. 17A-17H, which show perspective front, perspective rear, front, rear, top, bottom, left side and right side views, respectively, of an unmounted and unfastened girth strap buckle 10. Similarly to the embodiment shown in FIG. 1, the girth strap buckle 10 in FIGS. 15, 16 and 17A-17H includes a first crossbar 11 and a second crossbar 12 that extend across the frame 13 of the buckle 10. The first crossbar 11 extends so that the majority of the first crossbar 11 is offset from the plane of the frame 13.

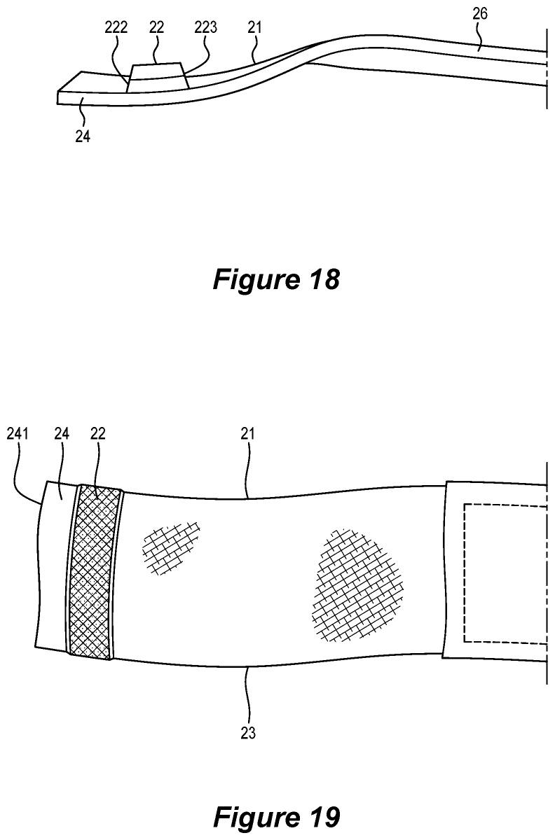

The buckle 10 has a first opening 14, a second opening 15 and a third opening 16. In this embodiment, the second opening 15 is smaller than the first opening 14 and the third opening 16. In particular, in these embodiments, the second opening has a width that is configured to be slightly narrower that the width of the stopper (see FIGS. 18 and 19) to be used with the buckle 10. That is, the dimensions of the second opening 15 are such that the stopper must be elastically deformed slightly to push the stopper through the opening 15. The height of the second opening 15 is selected to afford minimum clearance to the stopper 22 in the deformed state.

In the embodiments shown in FIGS. 1, 15, 16 and 17A-17H, the dimensions of the third opening 16 are larger than the second opening 15 as the third opening 16 is configured to accommodate the webbing 31 used to mount the buckle 10 to the saddle, as well as permit passage of the stopper during fastening. Similar to the second opening 15, the dimensions of the third opening 16 may be selected to provide minimum or force-fit clearance for the stopper when the webbing 31 is in situ.

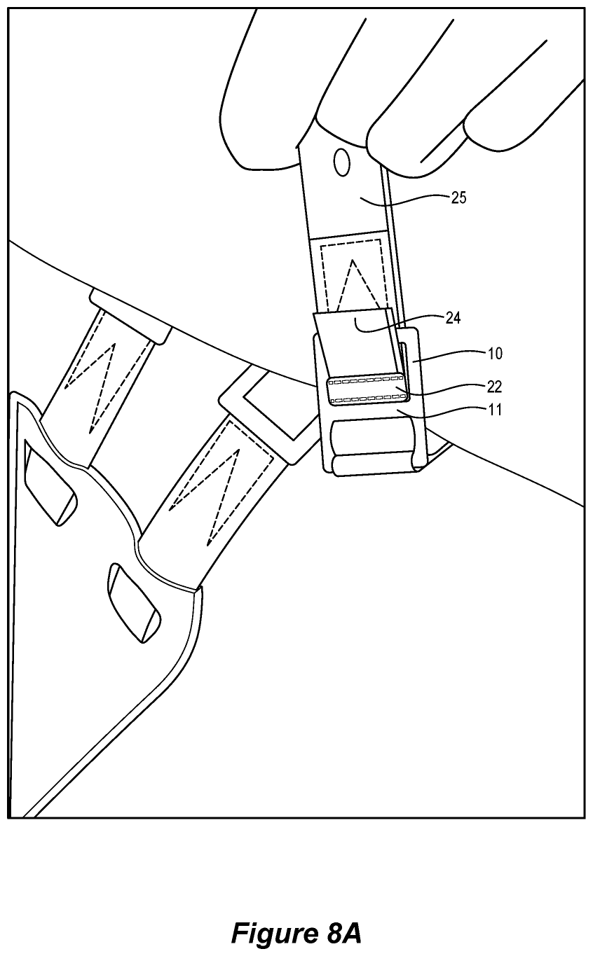

The first opening 14 is typically the largest of the openings, as shown in the illustrated embodiments. As described below with reference to FIGS. 9 and 10, the securing portion 25 of the girth strap 20 is drawn through the first opening 14 during fastening. Often, the securing portion 25 is made out of the same material(s) used for conventional girth straps, such as leather. Accordingly, the securing portion 25 is typically stiffer than the band 23 of the girth strap 20 and has a larger crimp angle than the band 23. Accordingly, the first opening 14 is often large to facilitate the stiffer securing portion 25 being threaded therethrough.

FIGS. 18 and 19 illustrate the fastening portion 21 of a girth strap. The band 23 is polyester webbing that has a seal 241 at the end of the tail 24. The stopper 22 is a short section of webbing that has been sewn onto the band 23. At each end of the stopper 22 there is a seal 222, 223. The face of the seal 223 is the part of the stopper 22 that will contact the retaining element of the buckle.

When the girth strap is fastened to the buckle, the fastening will be secure enough to withstand the loads typically encountered during use of the girth strap. The fastening between the fastening portion and the buckle may be durable enough that other parts of the girth strap will wear and require replacement before the fastening portion, such as the securing portion. Ideally, the girth strap will be durable enough that it has a comparable lifetime of use to conventional fixed girth straps. That is, the girth strap of the present invention may require replacement no more frequently than a fixed girth strap. However, when it does require replacement, it may be more readily and reliably replaced.

It will be appreciated that the mounting of the buckle to the saddle will be durable enough to permit the replacement of the girth strap. Thus, the buckle can be used to fasten a girth strap to the saddle for the lifetime of more than one detachably girth strap. The buckle may be mounted to the saddle using a loop of webbing (see FIG. 1). The loop may be formed by threading an end of the webbing and through the buckle and sewing the end back on to the webbing to close the loop. The length of webbing can be selected based on the tree geometry and the desired placement of the buckle. In some embodiments, the webbing, with the loop in situ may be up to 200 mm long, for example about 172 mm long or 160 mm long.

The webbing may be the same as the webbing used for the band of the girth strap. Thus, the webbing may be of the type described above. In some embodiments, heavier webbing than the band may be used for mounting the girth strap buckle to the saddle to enhance the longevity of the mounting. The webbing may be about 20 mm to about 30 mm wide (e.g. about 25.4 mm wide) and may be about 1.3 mm to about 2.0 mm thick (e.g. about 1.5 mm thick).

The webbing may be looped through a dedicated opening in the buckle. In some other embodiments, the webbing used to mount the buckle is also looped through an opening in the buckle through which the fastening portion of the girth strap is threaded.

The loop of webbing may be mounted to the saddle by mounting the webbing to the tree of the saddle. The webbing may be mounted using a fastener. For example, the webbing may be fastened to the tree with a rivet and washer.

With the girth strap system of the present invention, a girth strap can be detachably fastened to a saddle using the girth strap buckle mounted to the saddle. Detachably fastening the girth strap comprises threading the band through the girth strap buckle so that the stopper contacts the retaining element of the girth strap buckle to retain the fastening portion in the fastened configuration.

It is important to fasten the girth strap so that the stopper contacts the retaining element. If the stopper is not properly located, for example, if there is a section of band between the stopper and the position of the retaining element, the girth strap may become loose in use. Loosening of the girth strap and, consequently the girth, may lead to the saddle becoming loose, which can present a serious safety risk to the rider.

In embodiments where the girth strap buckle has first, second and third openings, such as the buckles 10 illustrated in FIGS. 1, 15, 16 and 17A-17H, the girth strap buckle has a first side and a second side opposite the first side; and threading the band through the girth strap buckle may comprise:

inserting the fastening portion into the third opening so that the stopper passes through the third opening from the second side to the first side, with the stopper projecting away from the second crossbar as the stopper passes through the third opening;

inserting the fastening portion into the second opening so that the stopper passes through the second opening from the first side to the second side;

inserting the fastening portion into the first opening;

drawing on the band so that the stopper contacts the first crossbar; and

passing the securing portion and part of the band through the first opening from the second side to the first side so that drawing the girth strap in a direction towards the first side also urges the stopper in a direction towards the first side.

The girth strap may be detached by reversing the steps used to fasten the girth strap to the saddle. The girth strap may be detached from the saddle by unfastening the fastening portion so that a replacement girth strap can be fastened. Alternatively, the girth strap may be detached to permit the configuration of the girth straps on the saddle to be adjusted, as discussed above. In addition, as the girth strap is a critical component of the saddle, the girth strap may be periodically detached so that it can be checked for wear. If significant wear is observed the strap may be replaced. However, if the strap is not significantly worn, it can be reattached to the saddle for further use.

FIGS. 2-10 illustrate the method of fastening the girth strap system including the buckle 10 illustrated in FIG. 1. The buckle 10 is mounted to the saddle 30 using the webbing 31. The webbing 31 is fixed to the tree (not shown) of the saddle. The buckle 10 is positions so that, when fastened, the girth straps will lie underneath the flap 32 of the saddle 30.

FIG. 2 shows the fastening portion 21 of the girth strap 20, comprising the stopper 22 and the band 23, being inserted into the third opening 16 of the buckle 10. The fastening portion 21 is inserted into the third opening 16 with the stopper 22 orientated so that it projects towards the top-bar 131 and away from the second crossbar 12 (see FIG. 1, the second crossbar 12 is underneath the girth strap 20 in FIG. 2).

The stopper 22 is positioned close to, but not at, the terminal end of the fastening portion 21. Accordingly, the fastening portion 21 includes a short tail 24. In this embodiment, the stopper is made of a short section of webbing that is sewn to the band 23.

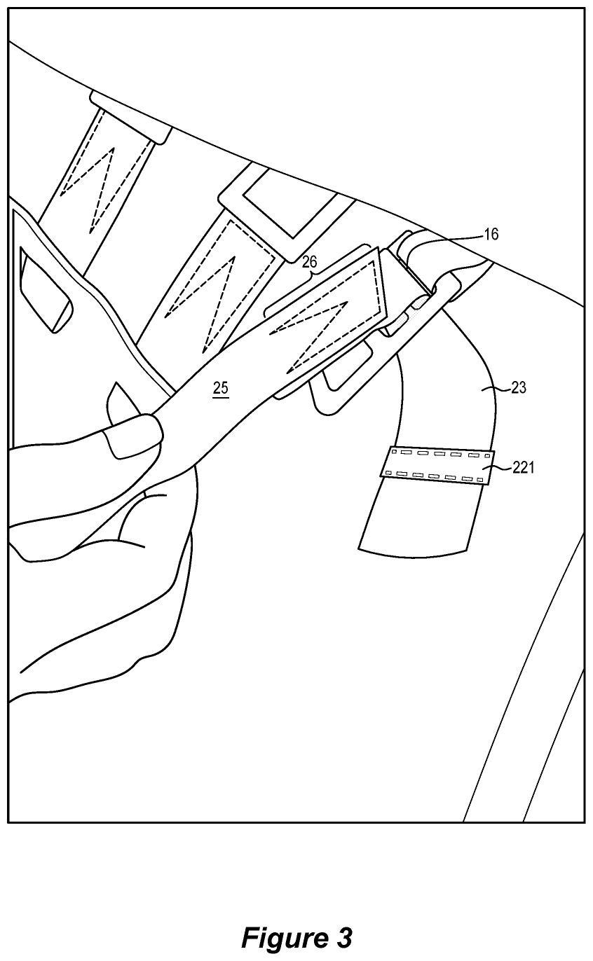

FIG. 3 shows that, in this embodiment, most of the length of the band 23 is drawn through the third opening 16. However, securing portion 25 of the girth strap 20 is not drawn into the buckle 10. It can be seen, in FIG. 3, that there is an intermediate section 26 at which the securing portion 25 and the fastening portion 21 are joined. In the illustrated embodiment, the securing portion 25 is a leather strap configured to correspond to known girth straps. The band 23 is a length of polyester webbing. As shown in FIG. 3, the band 23 and leather strap of the securing portion 25 are sewn together. In some embodiments, the band 23 and the securing portion 25 can be adhered together and sewn together to join them at the intermediate section 26.

In some embodiments, the leather strap may be tapered towards the end of the intermediate section 26 so that there is a gradual change in thickness. In some embodiments the change in thickness may extend along the last half to one third of the intermediate section 26. At the end of the intermediate section 26 the thickness, including the webbing forming the band 23, may be twice the thickness of the webbing alone.

FIG. 3 also shows the underside 221 of the stopper 22, where the stopper is fixed to the webbing that forms the band 23.

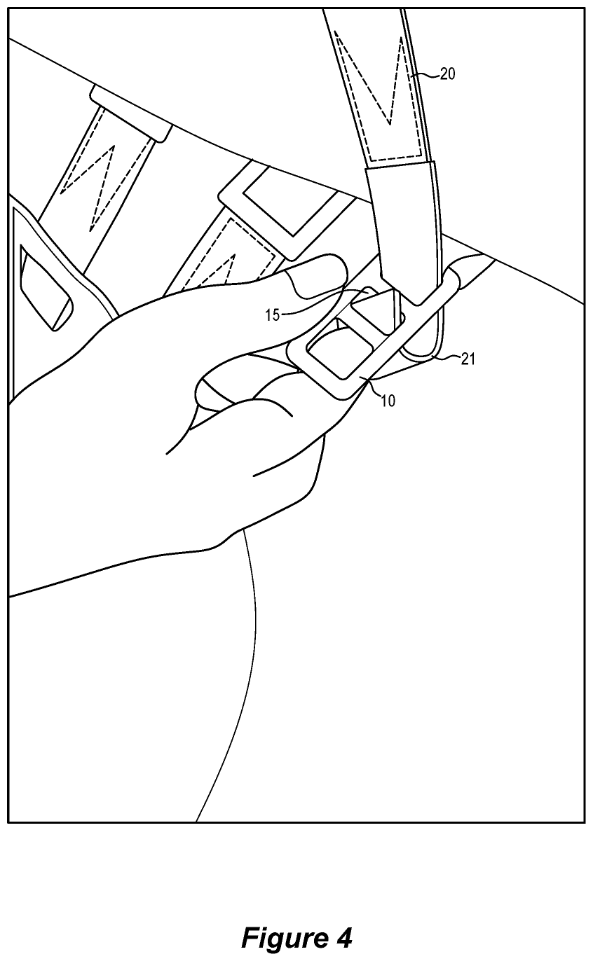

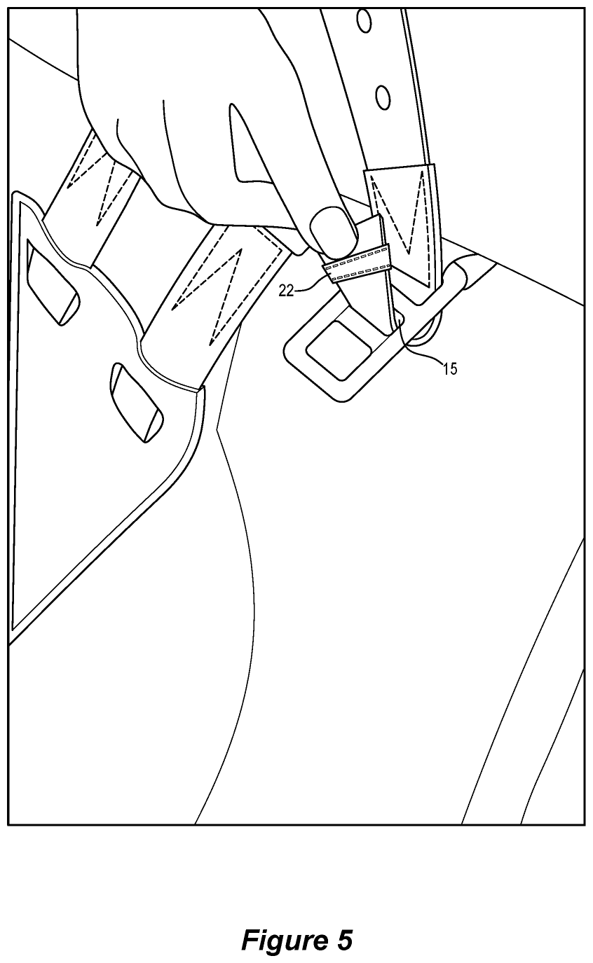

FIGS. 4 and 5 show the next step of fastening the girth strap 20 to the buckle 10. The fastening portion 21 is threaded through the second opening 15 of the buckle 10. The stopper 22 is drawn through the second opening 15. In some embodiments, the second opening 15 may be sized so that there is only minimum clearance for the stopper 22 across the height and/or width of the second opening 15. In some embodiments, the second opening 15 may be sized so that can be force-fit through the second opening 15. That is, the dimensions of the second opening 15 may be such that the stopper 22 must be elastically deformed slightly to push the stopper 22 through the opening 15. For example, the width of the second opening 15 may be slightly narrower than the width of the stopper 22.

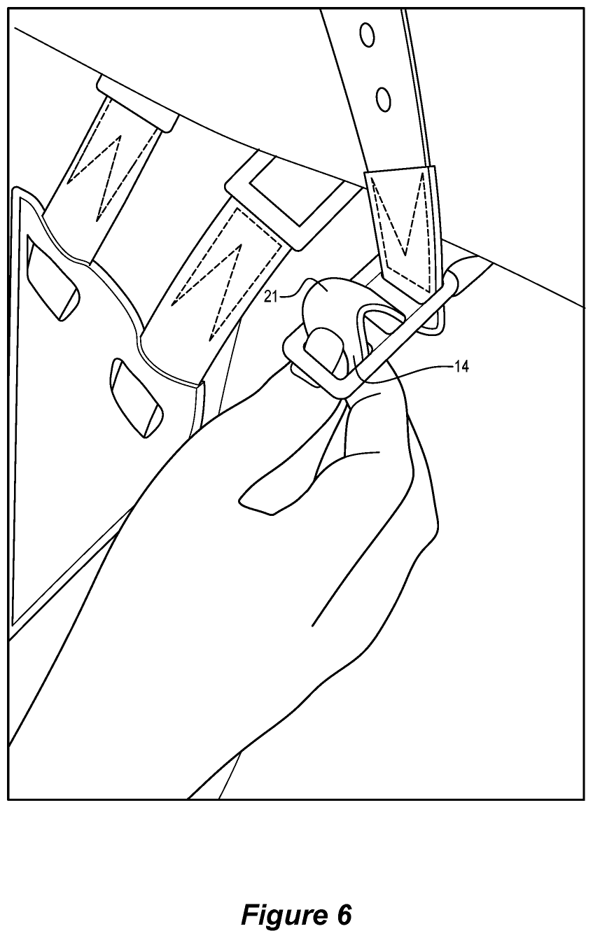

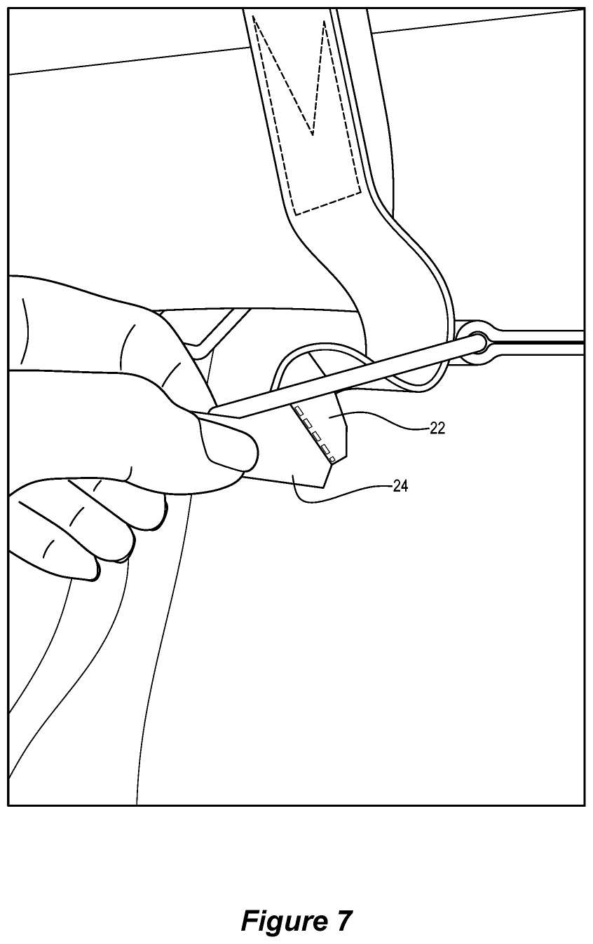

Once the stopper 22 is drawn through the second opening 15, the fastening portion 21 is threaded into the first opening 14, as shown in FIG. 6. The tail 24 of the fastening portion 21 can be used to draw the stopper 22 into the first opening 14 (see FIG. 7). Once the stopper 22 is positioned within the first opening 14, both the securing portion 25 and the tail 24 can be grasped and pulled to remove any slack in the fastening portion 21 threaded through the buckle 10. In removing any slack from the fastening portion 21 threaded through the buckle 10, the stopper 22 is located so that it contacts the contacts the first crossbar 11, which acts as the retaining element to retain the fastening portion in the fastened configuration, as shown in FIG. 8 and FIG. 8A.

As noted above, it is important to properly locate the stopper 22 so that it contacts the retaining element (i.e. first crossbar 11) so that the girth strap will not become loose in use. When the stopper 22 is properly located as shown in FIG. 8A, drawing on the securing portion 25 will urge the stopper 22 against the retaining element 11.

After the stopper 22 has been properly located so that it contacts the first crossbar 11 (i.e. the retaining element), the securing portion 25 is drawn through the first opening 14 (see FIGS. 9 and 10). Typically, the length of the band 23 between the stopper 22 and the intermediate portion 26 is sufficient so that the securing portion 25 can be completely drawn through the first opening 14 so that only the fastening portion 21 is located within the buckle when the girth strap system is in the fastened configuration as shown in FIG. 10. In the embodiment shown in FIG. 10, the securing portion 25 has been drawn through so that the end of the intermediate section 26 underlies the bottom-bar 132 of the buckle frame 13.

When it is necessary to replace the girth strap 20, the steps described above with reference to FIGS. 2-10 may be reversed to unfasten the girth strap 20 so that a new girth strap can be fastened to the buckle 10.

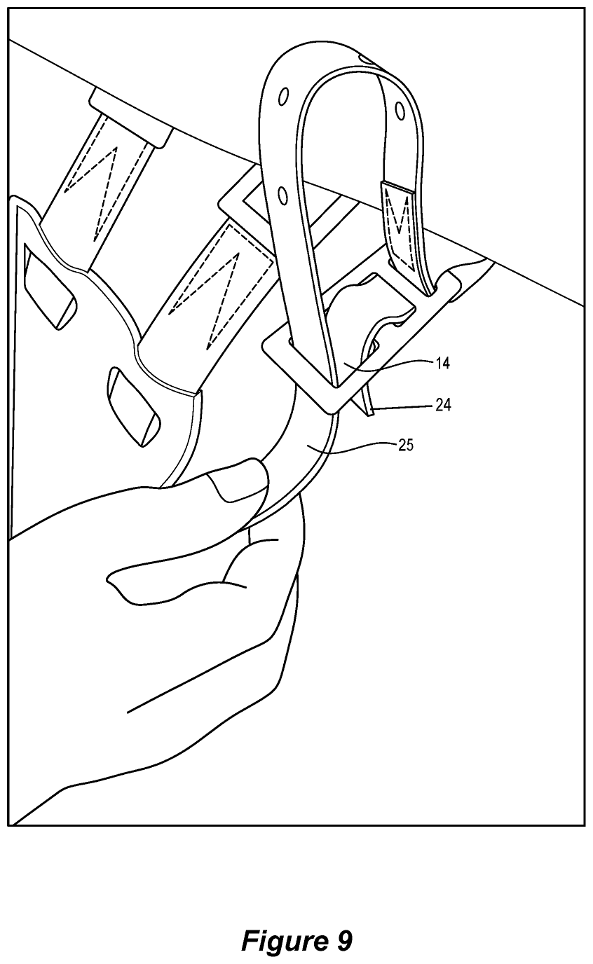

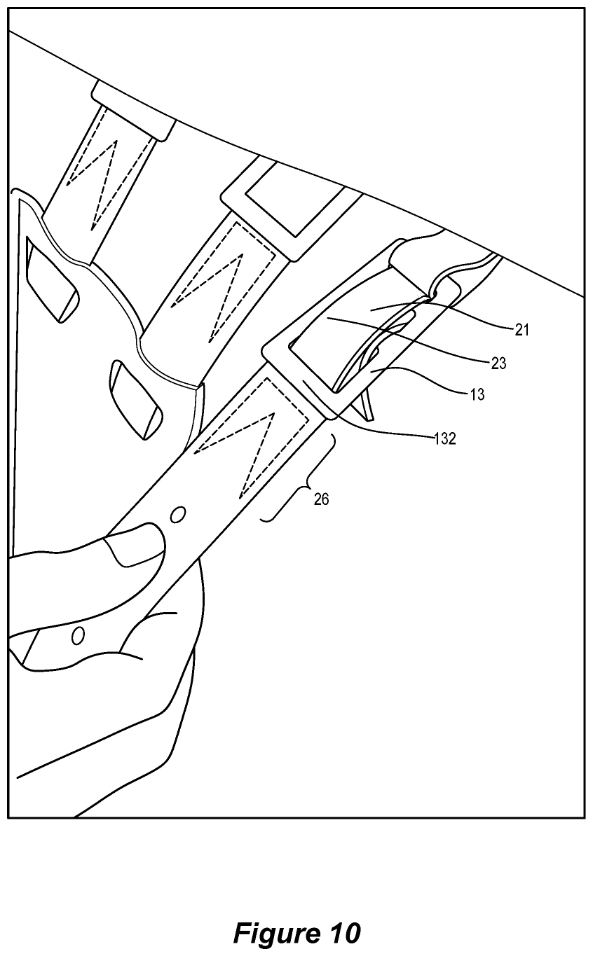

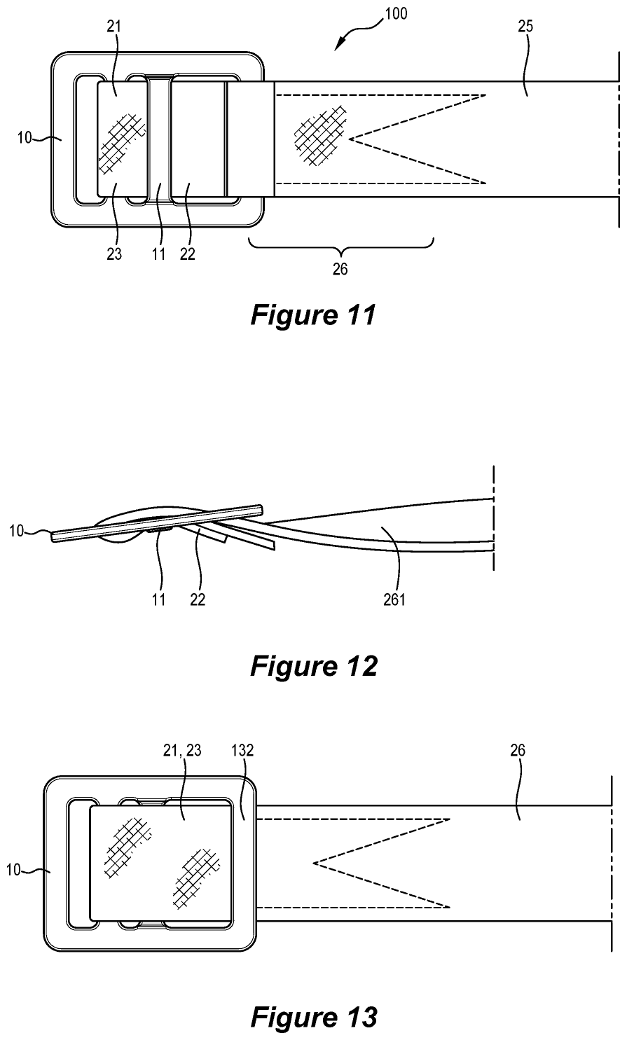

FIGS. 11-14 show a girth strap system 100, not mounted to a saddle, in the fastened configuration. In the fastened configuration, the stopper 22 is located so that it contacts the offset first crossbar 11. FIGS. 12 and 13 show that the securing portion 25 has been drawn through so that the end of the intermediate section 26 underlies the bottom-bar 132 of the buckle frame 13. In use, the girth strap may be drawn through the buckle 10 so that the end of the intermediate section 26 abuts the bottom-bar 132 of the buckle frame 13.

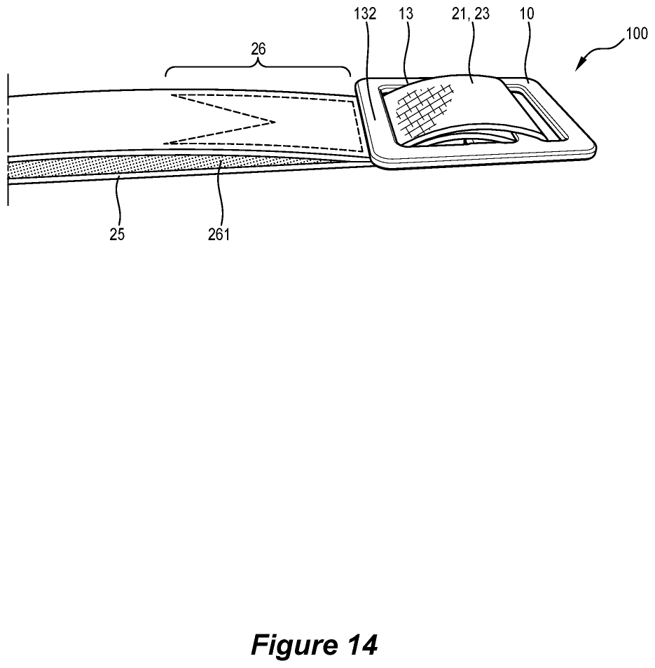

The intermediate section 26 has a tapered end 261 (see FIGS. 12 and 14). This tapered section 261 may provide a smoother transition from the buckle 10 to the securing portion 25. In use, this may result is a smoother profile beneath the flap of the saddle, so that the fastened buckle 10 and fastening portion 21 are less likely to be perceived by the rider.

The webbing of the band 23 may about one third to about one quarter the thickness of the leather of the securing portion 25. Also, the buckle 10 may be about half the thickness of the securing portion 25. As shown in FIG. 12, the fastened buckle 10 and fastening portion 21 may be thinner than the intermediate section 26. Furthermore, the fastened buckle 10 and fastening portion 21 may be substantially the same thickness or thinner than the securing portion 25. In some embodiments, the fastened buckle 10 and fastening portion 21 may be less than 6 mm thick, such as about 5 mm thick, for example, about 4.6 mm thick.

As shown in FIGS. 2-14, the girth strap buckle 10 has two faces. Accordingly, the buckle 10 has a first side and a second side opposite the first side. In the fastened configuration: the stopper 22 projects in a direction towards the first side and contacts the first crossbar 11; and the band 23 is threaded through the girth strap buckle so that the band 23 extends, from the stopper 22:
a. past the first crossbar 11 on the second side;
b. through the second opening 15 from the second side to the first side;
c. past the second crossbar 12 and through the third opening 16 from the first side to the second side; and
d. through the first opening 14 from the second side to the first side so that drawing the girth strap in a direction towards the first side also urges the stopper 22 in a direction towards the first side.

In these embodiments, in the fastened configuration, two layers of the band 23 lie on the second side of the first crossbar 11, while only one layer of the band lies against the second crossbar 12 on the second side of the buckle. Accordingly, by offsetting the first crossbar 11, the overall thickness of the fastened buckle may be reduced.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Embodiments have been described herein with reference to the accompanying drawings. However, some modifications to the described embodiments may be made without departing from the spirit and scope of the described embodiments, as described in the appended claims.

1. A girth strap system, said system comprising:
a girth strap buckle, said girth strap buckle being configured for mounting to a saddle; and
a girth strap configured to co-operate with the girth strap buckle to detachably fasten the girth strap to the saddle, said girth strap having a fastening portion at one end and a securing portion at the other end, wherein:
the securing portion is configured to co-operate with a girth for passing under the barrel of an animal to secure the saddle to the back of the animal; and
the fastening portion comprises a band and a stopper; and
the fastening portion is configured for threading the band through the girth strap buckle so that, in a fastened configuration, the stopper contacts a retaining element of the girth strap buckle to retain the fastening portion in the fastened configuration.

2. The girth strap system according to claim 1, wherein the stopper projects from a face of the band.

3. The girth strap system according to claim 1, wherein the girth strap buckle comprises a frame and the retaining element is a first crossbar extending across the frame.

4. The girth strap system according to claim 3, wherein the first crossbar is offset from the plane of the frame.

5. The girth strap system according to claim 3, wherein the girth strap buckle comprises a second crossbar extending across the frame.

6. The girth strap system according to claim 5, wherein:
the frame and the first crossbar delimit a first opening;
the frame, the first crossbar and the second crossbar delimit a second opening; and
the frame and the second crossbar delimit a third opening.

7. The girth strap system according to claim 6, wherein the girth strap buckle has a first side and a second side opposite the first side and further wherein, in the fastened configuration: the stopper projects in a direction towards the first side and contacts the first crossbar; and the band is threaded through the girth strap buckle so that the band extends, from the stopper:
past the first crossbar on the second side;
through the second opening from the second side to the first side;
past the second crossbar and through the third opening from the first side to the second side; and
through the first opening from the second side to the first side so that drawing the girth strap in a direction towards the first side also urges the stopper in a direction towards the first side.

8. The girth strap system according to claim 7, wherein the first side is closest to the animal.

9. The girth strap system according to claim 1, wherein, when in the fastened configuration, the girth strap buckle and the fastening portion together are less than 8 mm thick.

10. A girth strap buckle, said girth strap buckle being configured for mounting to a saddle and configured to co-operate with a girth strap to detachably fasten the girth strap to the saddle, wherein the girth strap buckle comprises a retaining element configured to contact a stopper of the girth strap, said girth strap having a fastening portion at one end and a securing portion at the other end, wherein:
the securing portion is configured to co-operate with a girth for passing under the barrel of an animal to secure the saddle to the back of the animal; and
the fastening portion comprises a band and the stopper; and
the fastening portion is configured for threading the band through the girth strap buckle so that, in a fastened configuration, the stopper contacts a retaining element of the girth strap buckle to retain the fastening portion in the fastened configuration.

11. The girth strap buckle according to claim 10, wherein the stopper projects from a face of the band.

12. The girth strap buckle according to claim 10, wherein the girth strap buckle comprises a frame and the retaining element is a first crossbar extending across the frame.

13. The girth strap buckle according to claim 12, wherein the first crossbar is offset from the plane of the frame.

14. The girth strap buckle according to claim 12, further comprising a second crossbar extending across the frame.

15. The girth strap buckle according to claim 14, wherein:
the frame and the first crossbar delimit a first opening;
the frame, the first crossbar and the second crossbar delimit a second opening; and
the frame and the second crossbar delimit a third opening.

16. A detachable girth strap, said girth strap being configured to co-operate with a girth strap buckle to detachably fasten the girth strap to a saddle, the girth strap buckle being configured for mounting to the saddle and comprising a retaining element configured to contact a stopper of the girth strap, wherein
the girth strap has a fastening portion at one end and a securing portion at the other end, and wherein:
the securing portion is configured to co-operate with a girth for passing under the barrel of an animal to secure the saddle to the back of the animal; and
the fastening portion comprises a band and the stopper; and
the fastening portion is configured for threading the band through the girth strap buckle so that, in a fastened configuration, the stopper contacts a retaining element of the girth strap buckle to retain the fastening portion in the fastened configuration.

17. The detachable girth strap according to claim 16, wherein the stopper projects from a face of the band.

18. A saddle comprising, on each side of a seat, one or more girth strap buckles according to claim 10 mounted to the saddle.

19. The saddle according to claim 18, wherein a detachable girth strap is fastened to at least one of the one or more girth strap buckles; and the girth strap has the fastening portion at one end and the securing portion at the other end and configured to co-operate with the girth strap buckle to detachably fasten to a saddle.

20. A method of detachably fastening a girth strap having a fastening portion at one end and a securing portion at the other end and configured to co-operate with a girth strap buckle to detachably fasten to the saddle according to claim 18, said method comprising threading the band through the girth strap buckle so that the stopper contacts the retaining element of the girth strap buckle to retain the fastening portion in the fastened configuration.

21. The method according to claim 20, wherein:
the girth strap buckle comprises a frame and the retaining element is a first crossbar extending across the frame; wherein the girth strap buckle comprises a second crossbar extending across the frame, wherein:
the frame and the first crossbar delimit a first opening;
the frame, the first crossbar and the second crossbar delimit a second opening; and
the frame and the second crossbar delimit a third opening; and
the girth strap buckle has a first side and a second side opposite the first side; and threading the band through the girth strap buckle comprises:
inserting the fastening portion into the third opening so that the stopper passes through the third opening from the second side to the first side, with the stopper projecting away from the second crossbar as the stopper passes through the third opening;
inserting the fastening portion into the second opening so that the stopper passes through the second opening from the first side to the second side;
inserting the fastening portion into the first opening;
drawing on the band so that the stopper contacts the first crossbar; and
passing the securing portion and part of the band through the first opening from the second side to the first side so that drawing the girth strap in a direction towards the first side also urges the stopper in a direction towards the first side.
